(19) United States
(12) Patent Application Publication
(10) Pub. No.: US 2020/0143140 A1
(43) Pub. Date: May 7, 2020

(54) EMPTY SPACE NOTIFICATION DEVICE, EMPTY SPACE NOTIFICATION SYSTEM, AND EMPTY SPACE NOTIFICATION METHOD

(71) Applicant: Mitsubishi Electric Corporation, Tokyo (JP)

(72) Inventors: Kentaro SAKANASHI, Tokyo (JP); Kanehide ARAI, Tokyo (JP)

(73) Assignee: Mitsubishi Electric Corporation, Tokyo (JP)

(21) Appl. No.: 16/607,522

(22) PCT Filed: Jun. 7, 2017
(86) PCT No.: PCT/JP2017/021123

§ 371 Date: Oct. 23, 2019

(51) Int. Cl. G06K 9/00; G06T 7/62; G08G 1/14

(52) U.S. Cl. CPC G06K 9/0063; G06T 7/62; G06T 2207/30264; G08G 1/143; G06T 2207/10032; G08G 1/146

(57) ABSTRACT

A parked-vehicle detecting unit (12c) detects a parked vehicle in a parking lot, using an image of the parking lot viewed from above. An empty space detecting unit (12d) detects, as an empty space, an area in the parking lot that does not have the parked vehicle detected by the parked-vehicle detecting unit (12c) and that is determined to be larger than a target vehicle to be guided. Then, an information generating unit (12g) generates notification information indicating the empty space detected by the empty space detecting unit (12d).

### TECHNICAL FIELD

The invention relates to an empty space notification device that assists in parking a vehicle in a parking lot.

### BACKGROUND ART

For example, Patent Literature 1 describes a navigation device that, when a vehicle enters a large parking lot, analyses an image transmitted from a flying object and finds empty parking spaces. The navigation device can also deliver an audio message such as “the fifth parking section from the right in the fourth row ahead of the current location is an empty space”.

### CITATION LIST

### Patent Literatures

Patent Literature 1: JP 2016-138853 A

### SUMMARY OF INVENTION

### Technical Problem

Some parking lots have parking frames by making white lines on the ground, and some parking lots do not have parking frames such as temporary parking lots.

For example, considering the content of the audio message, the navigation device of the above-described Patent Literature 1 is used for parking lots with parking frames. Since the parking frames are made in advance with a size that allows vehicles of almost all sizes to be parked, vehicles can be parked within empty parking frames without any problems. Therefore, when a parking lot has parking frames, there is no problem in notifying a driver of a found empty parking space without considering whether the space can really accommodate a vehicle as in the navigation device of the above-described Patent Literature 1.

On the other hand, when a parking lot does not have parking frames, for example, vehicles are parked irregularly, and thus, spaces between adjacent parked vehicles are also irregular. Hence, even if an empty space is found between parked vehicles, there is a possibility that the space cannot accommodate a vehicle to be parked.

Therefore, a conventional device that does not consider whether a vehicle can be really accommodated as in the above-described Patent Literature 1 has difficulty in notifying a person of an appropriate empty space in a parking lot with no parking frames.

The invention is made to solve a problem such as that described above, and an object of the invention is to obtain an empty space notification device that is also usable for a parking lot with no parking frames.

### Solution to Problem

An empty space notification device according to the invention includes: an image obtaining unit for obtaining an image of a parking lot viewed from above; a parked-vehicle detecting unit for detecting a parked vehicle in the parking lot, using the image; an empty space detecting unit for detecting one or more areas in the parking lot as one or more empty spaces, each of the one or more areas not having the parked vehicle detected by the parked-vehicle detecting unit, and being determined to be larger than a target vehicle to be guided; and an information generating unit for generating notification information indicating the one or more empty spaces detected by the empty space detecting unit.

### Advantageous Effects of Invention

The invention detects an area determined to be able to accommodate the target vehicle to be guided as an empty space, and thus can also be used for a parking lot with no parking frames.

### BRIEF DESCRIPTION OF DRAWINGS

FIG. 1 is a diagram showing an empty space notification device according to a first embodiment and components therearound.

FIG. 2 is a diagram schematically showing a positional relationship between a flying object and a target vehicle to be guided.

FIGS. 3A and 3B are diagrams showing exemplary hardware configurations of the empty space notification device according to the first embodiment.

FIG. 4 is a flowchart showing an example of processing performed by the flying object and an in-vehicle device.

FIG. 5 is a conceptual diagram of a process at step ST3 of FIG. 4.

FIG. 6 is an illustrative diagram of an entry space, an exit space, and door opening spaces.

FIG. 7 is a flowchart showing a process of detecting empty spaces, considering the exit space, the entry space, and the door opening spaces.

FIG. 8 is a diagram showing a parking layout.

FIG. 9 is a conceptual diagram of a process at step ST43 of FIG. 7.

FIG. 10 is a conceptual diagram of a process at step ST44 of FIG. 7.

FIG. 11 is a conceptual diagram of a process at step ST45 of FIG. 7.

FIGS. 12A and 12B are conceptual diagrams of a process at step ST6 of FIG. 4.

FIG. 13 is an example of an image represented by image information generated by an information generating unit.

FIG. 14 is a diagram showing an empty space notification device according to a second embodiment and components therearound.

FIG. 15 is a diagram showing an exemplary disposition of an attendant and a target vehicle to be guided.

### DESCRIPTION OF EMBODIMENTS

To describe the invention in more detail, modes for carrying out the invention will be described below with reference to the accompanying drawings.

### First Embodiment

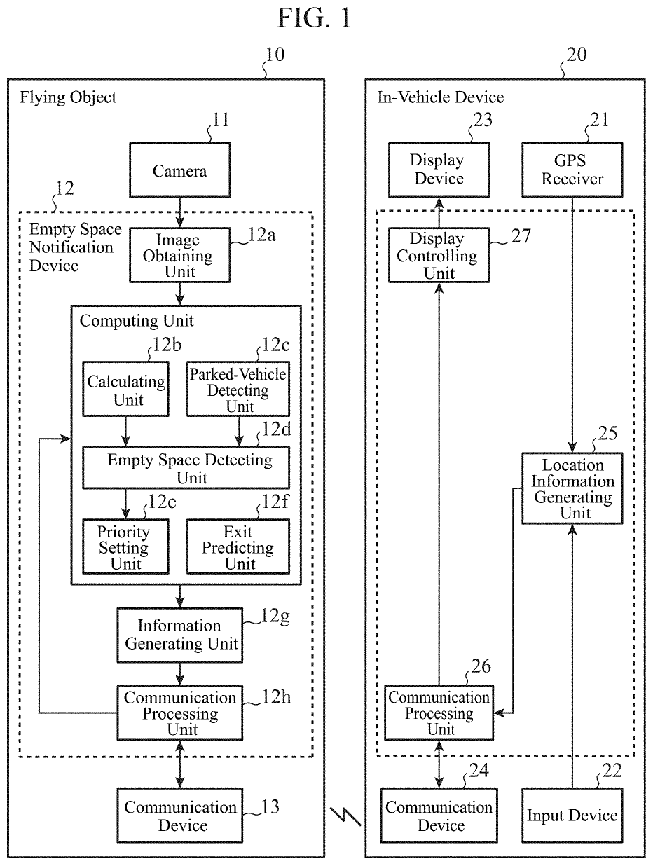

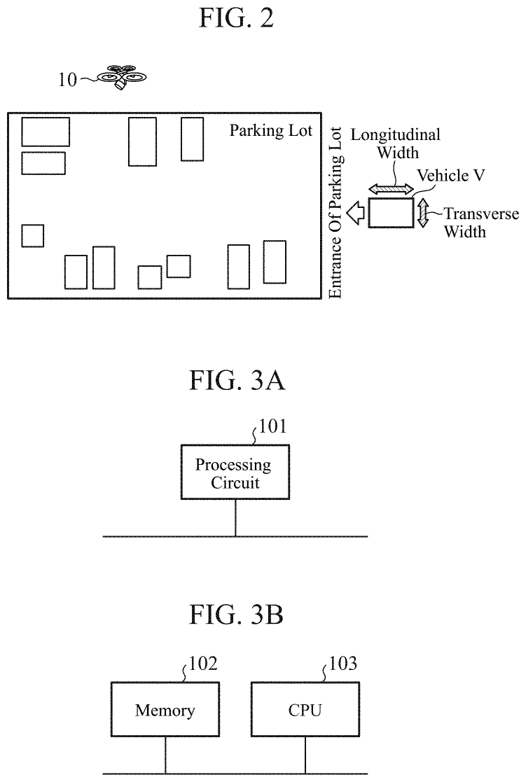

FIG. 1 is a diagram showing an empty space notification device 12 according to a first embodiment and components therearound. FIG. 1 shows a case in which the empty space notification device 12 is included in a flying object 10. An in-vehicle device 20 can communicate with the flying object 10. FIG. 2 is a diagram schematically showing a positional relationship between the flying object 10 and a vehicle V having the in-vehicle device 20 mounted thereon. FIG. 2 is a diagram of a parking lot viewed from a bird's-eye view. The vehicle V is a target vehicle to be guided that is about to enter the parking lot to park.

The flying object 10 is flying over the parking lot. The flying object 10 is, for example, a drone. The flying object 10 includes a camera 11, the empty space notification device 12, and a communication device 13.

The camera 11 is to create and output an image, and is included in the flying object 10 to create an image of the parking lot viewed from above. The camera 11 outputs the created image to the empty space notification device 12.

The empty space notification device 12 includes an image obtaining unit 12a, a calculating unit 12b, a parked-vehicle detecting unit 12c, an empty space detecting unit 12d, a priority setting unit 12e, an exit predicting unit 12f, an information generating unit 12g, and a communication processing unit 12h.

The image obtaining unit 12a obtains the image of the parking lot viewed from above which is outputted from the camera 11. The image obtaining unit 12a outputs the obtained image to a computing unit including the calculating unit 12b, the parked-vehicle detecting unit 12c, the empty space detecting unit 12d, the priority setting unit 12e, and the exit predicting unit 12f.

The calculating unit 12b calculates a size of the vehicle V by image processing using the image obtained by the image obtaining unit 12a. Note that the location of the vehicle V whose size is to be calculated is identified using location information generated by a location information generating unit 25 which will be described later. The calculating unit 12b outputs the calculated size of the vehicle V to the empty space detecting unit 12d.

The parked-vehicle detecting unit 12c detects parked vehicles which are already parked in the parking lot, by image processing using the image obtained by the image obtaining unit 12a. In FIG. 2, parked vehicles are represented by rectangles in the parking lot. The parked-vehicle detecting unit 12c outputs results of the detection to the empty space detecting unit 12d.

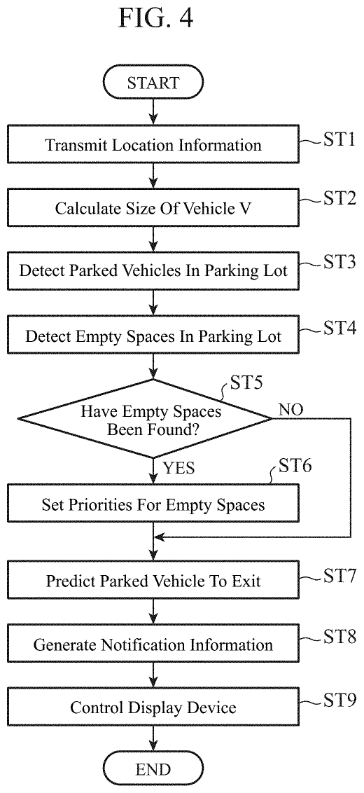

In response to processes performed by the calculating unit 12b and the parked-vehicle detecting unit 12c, the empty space detecting unit 12d detects areas each of which is in the parking lot and can accommodate the vehicle V, as empty spaces. Details of an empty space detecting process performed by the empty space detecting unit 12d will be described upon making a description using FIG. 4 which will be described later. The empty space detecting unit 12d outputs the detected empty spaces to the priority setting unit 12e and the information generating unit 12g.

The priority setting unit 12e sets a priority for each empty space detected by the empty space detecting unit 12d. The priority setting unit 12e sets, for example, a high priority for an empty space close to a vehicle entrance of the parking lot. The priority setting unit 12e outputs the set priorities to the information generating unit 12g.

The exit predicting unit 12f predicts a parked vehicle that is to exit soon among the parked vehicles which are already parked in the parking lot. The exit predicting unit 12f outputs the parked vehicle predicted to exit to the information generating unit 12g.

The information generating unit 12g generates notification information indicating the empty spaces detected by the empty space detecting unit 12d. The information generating unit 12g outputs the generated notification information to the communication processing unit 12h.

The communication processing unit 12h plays a role in exchanging information between the empty space notification device 12 and the communication device 13. For example, the communication processing unit 12h outputs the notification information generated by the information generating unit 12g to the communication device 13. In addition, for example, the communication processing unit 12h outputs information received by the communication device 13 from the in-vehicle device 20, to the computing unit.

The communication device 13 plays a role in performing communication between the flying object 10 and the in-vehicle device 20. The communication device 13 transmits the notification information, etc., outputted from the communication processing unit 12h to the in-vehicle device 20, and receives information from the in-vehicle device 20. The communication device 13 is a communication device that supports radio wave beacons, optical beacons, dedicated short range communications (DSRC), Wi-Fi, a mobile phone network such as long term evolution (LTE), or the like.

The in-vehicle device 20 includes a global positioning system (GPS) receiver 21, an input device 22, a display device 23, a communication device 24, the location information generating unit 25, a communication processing unit 26, and a display controlling unit 27.

The GPS receiver 21 receives radio waves outputted from GPS satellites, and outputs reception information to the location information generating unit 25.

The input device 22 accepts operations performed by a user such as a driver of the vehicle V. The input device 22 includes, for example, a touch panel or hardware keys such as buttons. When the input device 22 is operated by the user, the input device 22 outputs operation information indicating the details of the operation to the location information generating unit 25.

The display device 23 is controlled by the display controlling unit 27 to display an image. The display device 23 is, for example, a liquid crystal display (LCD).

The communication device 24 plays a role in performing communication between the in-vehicle device 20 and the flying object 10. The communication device 24 transmits location information (described later), etc., outputted from the communication processing unit 26 to the flying object 10, and receives the notification information, etc., from the flying object 10. The communication device 24 is, as with the communication device 13, a communication device that supports radio wave beacons, optical beacons, DSRC, Wi-Fi, a mobile phone network such as LTE, or the like.

The location information generating unit 25 generates location information using the reception information outputted from the GPS receiver 21 or the operation information outputted from the input device 22. The location information generating unit 25 outputs the generated location information to the communication processing unit 26.

The communication processing unit 26 plays a role in exchanging information between the location information generating unit 25 and the display controlling unit 27, and the communication device 13. For example, the communication processing unit 26 outputs the location information generated by the location information generating unit 25 to the communication device 24. In addition, for example, the communication processing unit 26 outputs information received by the communication device 24 from the flying object 10, to the display controlling unit 27.

The display controlling unit 27 controls an image to be displayed on the display device 23.

Next, exemplary hardware configurations of the empty space notification device 12 will be described using FIGS. 3A and 3B.

The functions of the image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h of the empty space notification device 12 are implemented by a processing circuit. The processing circuit may be dedicated hardware or may be a central processing unit (CPU) that executes programs stored in a memory. The CPU is also called a central processing device, a processing device, an arithmetic unit, a microprocessor, a microcomputer, a processor, or a digital signal processor (DSP).

FIG. 3A is a diagram showing an exemplary hardware configuration for when the functions of the image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h are implemented by a processing circuit 101 which is dedicated hardware. The processing circuit 101 corresponds, for example, to a single circuit, a combined circuit, a programmed processor, a parallel programmed processor, an application specific integrated circuit (ASIC), a field programmable gate array (FPGA), or a combination thereof The functions of the image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h may be implemented by combining together two or more processing circuits 101, or may be implemented by a single processing circuit 101.

FIG. 3B is a diagram showing an exemplary hardware configuration for when the functions of the image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h are implemented by a CPU 103 that executes programs stored in a memory 102. In this case, the functions of the image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h are implemented by software, firmware, or a combination of software and firmware. The software and firmware are described as programs and stored in the memory 102. The CPU 103 implements the functions of the image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h by reading and executing the programs stored in the memory 102. Namely, the empty space notification device 12 includes the memory 102 for storing programs, etc., that cause steps ST2 to ST8 shown in a flowchart of FIG. 4 which will be described later to be consequently performed. In addition, these programs can also be said to be programs that cause a computer to execute a procedure or a method which each of the image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h uses. Here, the memory 102 corresponds, for example, to a nonvolatile or volatile semiconductor memory, such as a random access memory (RAM), a read only memory (ROM), a flash memory, an erasable programmable ROM (EPROM), and an electrically erasable programmable ROM (EEPROM), or a disc-like recording medium, such as a magnetic disk, a flexible disk, an optical disc, a compact disc, a MiniDisc, and a digital versatile disc (DVD).

Note that some of the functions of the image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h may be implemented by dedicated hardware, and some may be implemented by software or firmware. For example, the functions of the image obtaining unit 12a, the calculating unit 12b, the parked-vehicle detecting unit 12c, and the empty space detecting unit 12d can be implemented by a processing circuit which is dedicated hardware, and the functions of the priority setting unit 12e, the exit predicting unit 12f, the information generating unit 12g, and the communication processing unit 12h can be implemented by a processing circuit reading and executing programs stored in a memory.

As such, the processing circuit can implement the functions of the above-described image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h by using hardware, software, firmware, or a combination thereof.

Note that the location information generating unit 25, the communication processing unit 26, and the display controlling unit 27 of the in-vehicle device 20 can also be likewise implemented by a processing circuit 101 such as that shown in FIG. 3A, or a memory 102 and a CPU 103 such as those shown in FIG. 3B.

Next, an example of processing performed by the flying object 10 and the in-vehicle device 20 which are configured in the above-described manner will be described using a flowchart shown in FIG. 4. Although the following example describes a parking lot with no parking frames, processes shown below are also applicable to a parking lot with parking frames.

First, the location information generating unit 25 generates location information. The location information generated by the location information generating unit 25 is transmitted to the flying object 10 through the communication processing unit 26 and the communication device 24 (step ST1). By using the location information, the flying object 10 can know where the vehicle V, which is a target vehicle to be guided, is.

The location information generating unit 25 generates location information using, for example, reception information from the GPS receiver 21. Alternatively, the location information generating unit 25 may generate location information using operation information outputted from the input device 22. When the flying object 10 has already transmitted an image of the parking lot created by the camera 11 to the in-vehicle device 20 and the image is displayed on the display device 23, the user touches the vehicle V in the image, using a touch panel which is the input device 22. The location information generating unit 25 generates information indicating a touched location in the image as location information, using operation information outputted from the input device 22.

Alternatively, in a case in which a location where a vehicle is recognized as a target vehicle to be guided is set in advance by a parking lot manager, etc., when the vehicle V has arrived at the location, e.g., a vehicle entrance of the parking lot, a “message requesting for notification of empty spaces” may be transmitted as location information to the flying object 10 from the in-vehicle device 20. When the flying object 10 receives the message, the flying object 10 determines that the vehicle V is located at the set location, e.g., the vehicle entrance of the parking lot.

The flying object 10 receives, by using the communication device 13, the location information transmitted from the in-vehicle device 20, and the location information is outputted to the calculating unit 12b through the communication processing unit 12h.

Subsequently, the calculating unit 12b calculates, by image processing, a size of the vehicle V present at a location indicated by the location information, using an image obtained by the image obtaining unit 12a (step ST2). By this, as shown in FIG. 2, a rough longitudinal width and a rough transverse width of the vehicle V are calculated. Here, the length in a front-rear direction of the vehicle is the longitudinal width, and the length in a left-right direction of the vehicle is the transverse width. Note that the image obtaining unit 12a obtains an image of the parking lot viewed from above from the camera 11 at appropriate timing. To calculate a size of the vehicle V using the image obtained by the image obtaining unit 12a, the camera 11 is provided in such a manner that a vehicle that is about to enter the parking lot is also included in a shooting range.

The calculating unit 12b outputs the calculated size of the vehicle V to the empty space detecting unit 12d.

Subsequently, the parked-vehicle detecting unit 12c detects, by image processing, parked vehicles which are already parked in the parking lot, using the image obtained by the image obtaining unit 12a (step ST3). For example, an image obtained when there is not even a single parked vehicle in the parking lot is saved in a memory which is not shown, and the parked-vehicle detecting unit 12c can detect parked vehicles by a differential process using the image. At this time, the parked-vehicle detecting unit 12c outputs the locations, sizes, and orientations of the parked vehicles as results of the detection to the empty space detecting unit 12d.

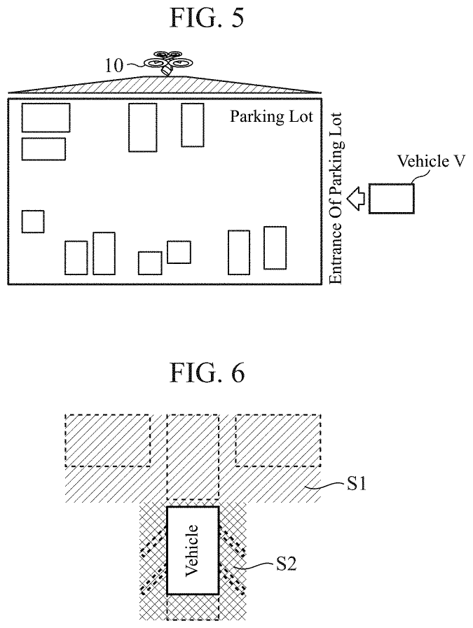

FIG. 5 is a conceptual diagram of a process at step ST3. Parked vehicles are detected as indicated by rectangles in the parking lot in FIG. 5. Note that the parked-vehicle detecting unit 12c may also detect obstacles in the parking lot in addition to parked vehicles. In addition, the orientation of a parked vehicle is only required to indicate in which direction an object detected as a parked vehicle is elongated, and does not need to indicate details, i.e., in which direction the front of the parked vehicle is oriented and in which direction the rear of the parked vehicle is oriented.

Subsequently, in response to processes at steps ST2 and ST3, the empty space detecting unit 12d detects, as empty spaces, areas that are in the parking lot and that can accommodate the vehicle V (step ST4).

The simplest method of detecting an empty space is a method of detecting an area that can accommodate the vehicle V within an area that is in the parking lot and that does not have parked vehicles. The empty space detecting unit 12d extracts an area that does not have the parked vehicles detected by the parked-vehicle detecting unit 12c, from the image obtained by the image obtaining unit 12a. Note that the empty space detecting unit 12d may perform this process without using an image of the parking lot. For example, the empty space detecting unit 12d saves information such as the size of the parking lot in a memory which is not shown. By disposing the parked vehicles on a plane represented by the information in accordance with the detection by the parked-vehicle detecting unit 12c, the empty space detecting unit 12d can extract an area that is in the parking lot and that does not have the parked vehicles. Then, the empty space detecting unit 12d divides the extracted area into rectangular areas as appropriate, and determines, for each divided area, whether the area can accommodate the vehicle V having the size calculated by the calculating unit 12b. An area determined at this time to be able to accommodate the vehicle V is detected as an empty space.

Note that when the empty space detecting unit 12d detects empty spaces, by considering the exit, entry, and the like, of vehicles, more appropriate empty spaces can be detected more accurately. A method of detecting an empty space for this case will be described in detail using FIGS. 6 to 11.

FIG. 6 is an illustrative diagram of spaces that are desired to be considered upon detecting empty spaces. In front of or behind a vehicle there is an exit space required when the vehicle exits, or an entry space required when the vehicle enters. The exit space and the entry space are represented as a space S1 in FIG. 6. When there is some kind of object in the space S1, it is difficult for the vehicle to enter or exit.

In addition, to the left and right of the vehicle there are door opening spaces required when doors of the vehicle open. The door opening spaces are represented as a space S2 in FIG. 6. Note that when a trunk lid is also considered, as shown in FIG. 6, a door opening space is also present in a longitudinal width direction of the vehicle. Since, as described already, details, i.e., in which direction the front of the vehicle is oriented and in which direction the rear of the vehicle is oriented, are not detected, spaces for the trunk lid are set in two areas in the longitudinal width direction of the vehicle. However, since, as shown in FIG. 6, one of the spaces for the trunk lid overlaps the space S1, as shown in FIG. 6, the space S2 is set to the left of the vehicle, to the right of the vehicle, and on the opposite side to the space S1 viewed from the vehicle in the longitudinal width direction. When there is some kind of object in the space S2, it is difficult to open the doors of the vehicle. Note that as a door opening space, only a space for opening a driver's door may be considered.

The entry space, exit space, and door opening space can be calculated by the empty space detecting unit 12d, using characteristic information unique to the vehicle such as the longitudinal and transverse widths of the vehicle, the longitudinal and transverse widths of the vehicle for when the doors are opened, and a minimum turning radius.

Characteristic information unique to the target vehicle to be guided is, for example, transmitted from the in-vehicle device 20 to the flying object 10 at the same time as when location information is transmitted at step ST1.

In addition, for characteristic information unique to each parked vehicle, unique characteristic information that is transmitted when the parked vehicle is a target vehicle to be guided is accumulated in the flying object 10.

In addition, when characteristic information unique to the target vehicle to be guided and characteristic information unique to the parked vehicles cannot be obtained, average characteristic information on vehicles may be used. Note that for the longitudinal and transverse widths of the vehicle, the rough longitudinal width and the rough transverse width which are calculated at step ST2 may be substituted.

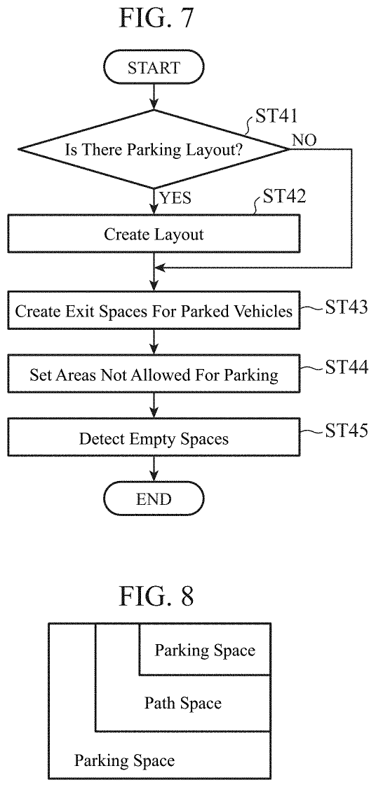

A process of detecting empty spaces considering an entry space, an exit space, and door opening spaces such as those described above will be described using a flowchart shown in FIG. 7.

First, the empty space detecting unit 12d determines whether there is a parking layout (step ST41). The parking layout indicates how to use the parking lot which is assumed by the parking lot manager, etc. For example, as shown in FIG. 8, information indicating parking spaces and a path space for vehicles to travel is saved in advance in a memory which is not shown, as a parking layout.

If there is no parking layout (step ST41; NO), i.e., a parking layout is not saved in the memory which is not shown, processing transitions to a process at step ST43 which will be described later.

On the other hand, if there is a parking layout (step ST41; YES), i.e., a parking layout is saved in the memory which is not shown, the empty space detecting unit 12d creates a layout such as that shown in FIG. 8 (step ST42).

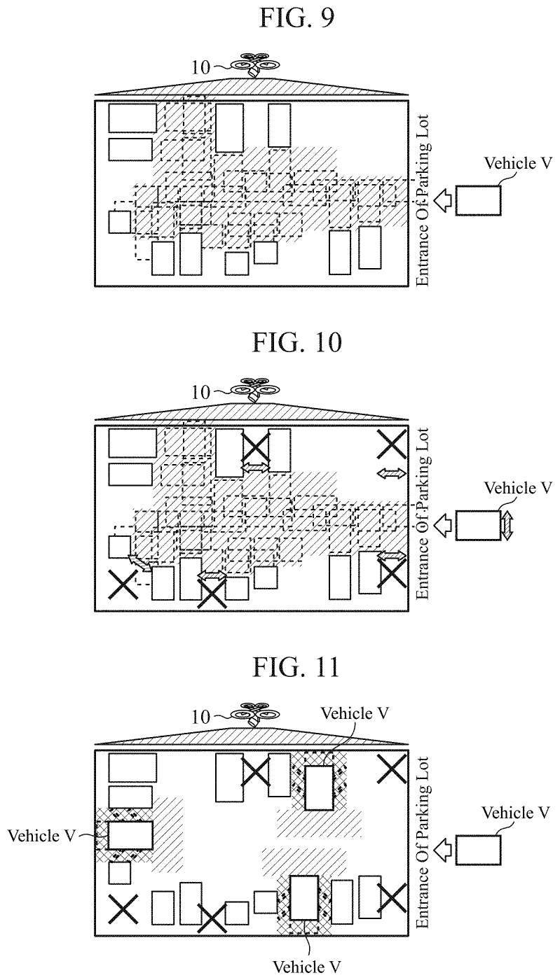

Subsequently, as shown in FIG. 9, the empty space detecting unit 12d creates exit spaces for parked vehicles (step ST43). As shown in FIG. 9, the created exit spaces can be considered to form a virtual path through which the parked vehicles pass when exiting.

Note that when there is a layout created at step ST42, the empty space detecting unit 12d also uses a path space shown in the layout, as an exit space, for subsequent processes. In addition, at step ST43, the empty space detecting unit 12d may also create door opening spaces for the parked vehicles.

Subsequently, the empty space detecting unit 12d sets areas not allowed for parking (step ST44). The empty space detecting unit 12d sets, for example, as indicated by the mark X in FIG. 10, areas near a vehicle entrance of the parking lot and areas narrower than the transverse width of the vehicle V, as areas not allowed for parking. In addition, the empty space detecting unit 12d may set areas that are freely set by the parking lot manager, as areas not allowed for parking.

Subsequently, the empty space detecting unit 12d detects empty spaces in the parking lot from which the parked vehicles, the exit spaces for the parked vehicles, and the set areas not allowed for parking are excluded (step ST45). At this time, the empty space detecting unit 12d detects, as shown in FIG. 11, areas that are determined to be able to accommodate the entry space and door opening spaces for the vehicle V, as empty spaces. Note that in FIG. 11, for an easy view of the drawing, the entry space and door opening spaces for the vehicle V are hatched, with the exit spaces for the parked vehicles shown in FIGS. 9 and 10 not shown.

As described above, by considering the exit, entry, and the like, of vehicles, more appropriate empty spaces can be detected more accurately.

Processes following the process of detecting empty spaces by the empty space detecting unit 12d will be described using the flowchart shown in FIG. 4 again.

The empty space detecting unit 12d determines whether empty spaces have been found (step ST5). If empty spaces have not been found (step ST5; NO), e.g., when the parking lot is fully occupied, processing transitions to a process at step ST7 which will be described later.

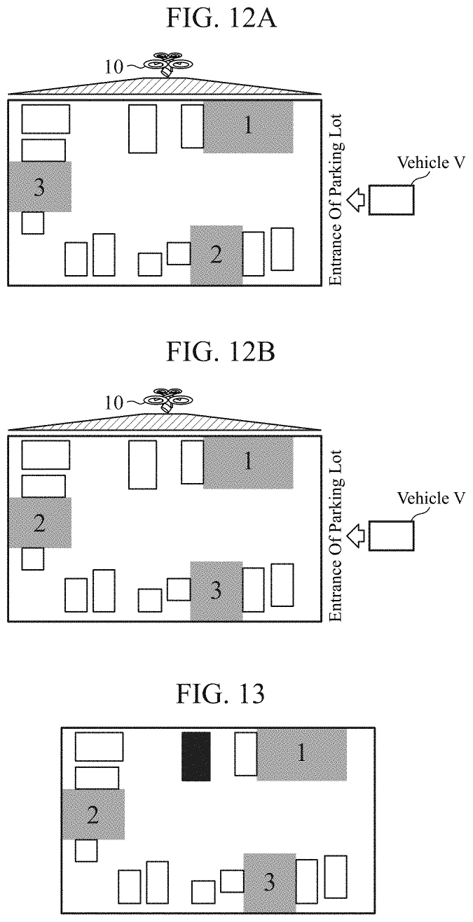

On the other hand, if empty spaces have been found (step ST5; YES), the priority setting unit 12e sets a priority for each empty space detected by the empty space detecting unit 12d (step ST6). For example, as shown in FIG. 12A, the priority setting unit 12e sets higher priorities for spaces closer to the vehicle entrance of the parking lot. Alternatively, as shown in FIG. 12B, the priority setting unit 12e sets higher priorities for spaces with wider width. Alternatively, the priority setting unit 12e may set higher priorities for spaces closer to a vehicle exit of the parking lot or spaces closer to or farther from a pedestrian entrance of the parking lot. The priority setting unit 12e outputs the set priorities to the information generating unit 12g. A condition used at setting priorities is, for example, transmitted from the in-vehicle device 20 to the flying object 10 at the same time as when location information is transmitted at step ST1. For example, when the user thinks that he/she wants to park his/her vehicle at a location close to the vehicle entrance of the parking lot, the user sets in advance such a thought in the in-vehicle device 20.

Subsequently, the exit predicting unit 12f predicts a parked vehicle that is to exit soon among the parked vehicles which are already parked in the parking lot (step ST7). For example, the exit predicting unit 12f detects and manages a state of people getting in or out of their parked vehicles, by periodically obtaining an image outputted from the camera 11 through the image obtaining unit 12a and performing image processing on the image. For the state of people getting in or out of their parked vehicles, four categories are considered: a person has not gotten out of a vehicle; one or more persons have gotten out of a vehicle; one or more persons have gotten out of a vehicle and one or more persons have come back; and the same number of people as those having gotten out of a vehicle have come back. The exit predicting unit 12f predicts a parked vehicle that is to exit soon, using the detected state of people getting in or out of their parked vehicles. When a person has not gotten out of a vehicle, the likelihood of vehicle exit is lowest, and the likelihood of vehicle exit increases in the following order: when one or more persons have gotten out of a vehicle; when one or more persons have gotten out of a vehicle and one or more persons have come back; and when the same number of people as those having gotten out of a vehicle have come back. Alternatively, the exit predicting unit 12f may predict whether a parked vehicle exits, on the basis of the parking time of the parked vehicle. The exit predicting unit 12f outputs to the information generating unit 12g a parked vehicle that is predicted to exit, e.g., a parked vehicle to which the same number of people as those having gotten out of the vehicle have come back.

Subsequently, the information generating unit 12g generates notification information indicating the empty spaces detected by the empty space detecting unit 12d (step ST8). The information generating unit 12g generates, for example, as shown in FIG. 13, image information in which the empty spaces are differentiated and shown, for example, by coloring (colored in gray in the example shown in the diagram), as notification information. In addition, when priorities are set by the priority setting unit 12e, it is preferable that the information generating unit 12g generates, as shown in FIG. 13, image information in which the priorities are also shown. In addition, when there is a parked vehicle that is predicted by the exit predicting unit 12f to exit, e.g., a parked vehicle to which the same number of people as those having gotten out of the vehicle have come back, it is preferable that the information generating unit 12g generates, as shown in FIG. 13, image information in which the parked vehicle is differentiated and shown, for example, by coloring (colored in black in the example shown in the diagram).

The notification information generated by the information generating unit 12g is transmitted to the in-vehicle device 20 through the communication processing unit 12h and the communication device 13. The display controlling unit 27 obtains the notification information through the communication device 24 and the communication processing unit 26, and controls the display device 23 to display an image represented by the notification information (step ST9).

Note that the information generating unit 12g may generate image information including a text message, e.g., “there is a wide empty space on the right side of the entrance”, “there is an empty space for one vehicle on the left side of the entrance”, or “there is an empty space for one vehicle at the end of the parking lot”. These messages are finally displayed on the display device 23. In addition, the information generating unit 12g may generate audio information indicating these messages, as notification information. After the audio information is received by the in-vehicle device 20, the audio information is outputted from an in-vehicle speaker which is not shown, by an audio controlling unit of the in-vehicle device 20 which is not shown.

In addition, the information generating unit 12g may generate image information by superimposing empty spaces, priorities, and a parked vehicle to exit on an image generated by the camera 11, or may generate image information in which empty spaces, priorities, and a parked vehicle to exit are shown in a simple diagram instead of the image generated by the camera 11. In the former case it is easy for the user to grasp the state of the parking lot, and in the latter case the data amount of image information can be suppressed.

In this manner, even if a parking lot does not have parking frames, the empty space notification device 12 can detect empty spaces with sizes that can accommodate the vehicle V, and notify the user of the empty spaces through the in-vehicle device 20.

Note that the above description shows a case in which the empty space notification device 12 is included in the flying object 10. However, the empty space notification device 12 may be built in the in-vehicle device 20. In this case, the empty space notification device 12 obtains information as appropriate from the flying object 10 and performs processes, the information being required to detect empty spaces, e.g., an image generated by the camera 11. In addition, likewise, the empty space notification device 12 may be built in an external server. The external server is communicably connected to both the flying object 10 and the in-vehicle device 20. In addition, likewise, the empty space notification device 12 may be built in a portable terminal carried in a vehicle, such as a smartphone and a tablet terminal. The portable terminal is communicably connected to both the flying object 10 and the in-vehicle device 20.

In addition, the empty space notification device 12 may be formed across the flying object 10 and the in-vehicle device 20 by providing the image obtaining unit 12a, the calculating unit 12b, the parked-vehicle detecting unit 12c, the empty space detecting unit 12d, the priority setting unit 12e, the exit predicting unit 12f, the information generating unit 12g, and the communication processing unit 12h of the empty space notification device 12 in the flying object 10 and the in-vehicle device 20 in a distributed manner.

In addition, instead of in the flying object 10, a camera may be provided at a location at which a parking lot can be viewed from above, and the empty space notification device 12 may be included in the camera, or the empty space notification device 12 may be provided at a freely-selected location in the parking lot in such a manner as to be able to communicate with the camera.

In addition, it is desirable that the priority setting unit 12e and the exit predicting unit 12f be included in the empty space notification device 12 because the amount of information grasped by the user increases. However, when only empty spaces with sizes that can accommodate the vehicle V are to be notified, the priority setting unit 12e and the exit predicting unit 12f may be excluded from the empty space notification device 12.

In addition, the empty space detecting unit 12d may determine whether the vehicle V can be accommodated in an area in which a parked vehicle predicted by the exit predicting unit 12f to exit is parked, and only when it is determined that the vehicle V can be accommodated in the area, as shown in FIG. 13, the parked vehicle that is likely to exit may be notified to the user.

In addition, the flying object 10 may be provided in a parking lot and may be flying over the parking lot at all times, or the flying object 10 may be provided in a target vehicle to be guided, and when the target vehicle to be guided enters a parking lot, the flying object 10 may start flying over the parking lot. In the latter case, since the flying object 10 is dedicated for the target vehicle to be guided, the flying object 10 may store in advance the size of the target vehicle to be guided in a memory which is not shown. In this case, without the need to provide the calculating unit 12b in the flying object 10, the empty space detecting unit 12d can read the size of the target vehicle to be guided from the memory which is not shown, and use it for processes.

As described above, according to the empty space notification device 12 according to the first embodiment, even if a parking lot does not have parking frames, empty spaces with sizes that can accommodate the vehicle V can be detected and notified to the user through the in-vehicle device 20. In other words, the empty space notification device 12 can also be used for a parking lot with no parking frames. In addition, even when a parking lot with parking frames is targeted, as a matter of course, the empty space notification device 12 can likewise detect empty spaces by performing the processes described above.

In addition, the empty space detecting unit 12d detects empty spaces using exit spaces required when parked vehicles exit, an entry space required when a target vehicle to be guided enters, and door opening spaces required when the doors of the target vehicle to be guided open. By this, more appropriate empty spaces can be detected more accurately.

In addition, the empty space detecting unit 12d calculates the entry space and the door opening spaces, using characteristic information unique to the target vehicle to be guided. By this, the entry space and the door opening spaces for the target vehicle to be guided can be more accurately calculated.

In addition, the priority setting unit 12e that sets a priority for each empty space detected by the empty space detecting unit 12d is provided, and the information generating unit 12g generates notification information indicating the priorities for the empty spaces. This enables the user to know which empty space is more preferable.

In addition, the exit predicting unit 12f that predicts a parked vehicle to exit, using a state of people getting in or out of their parked vehicles in a parking lot is provided, and the information generating unit 12g generates notification information indicating the parked vehicle predicted by the exit predicting unit 12f to exit. This enables the user to know which place is going to be a new empty space. This is particularly useful when the parking lot is fully occupied.

In addition, the calculating unit 12b that calculates the size of the target vehicle to be guided using an image is provided. By this, even if the flying object 10 is provided in a parking lot, the size of the target vehicle to be guided can be calculated and used for processes.

### Second Embodiment

In the first embodiment, the description is made assuming that empty spaces are notified to a driver of a target vehicle to be guided. In a second embodiment, a mode in which empty spaces are notified to an attendant who directs vehicles that enter a parking lot will be described.

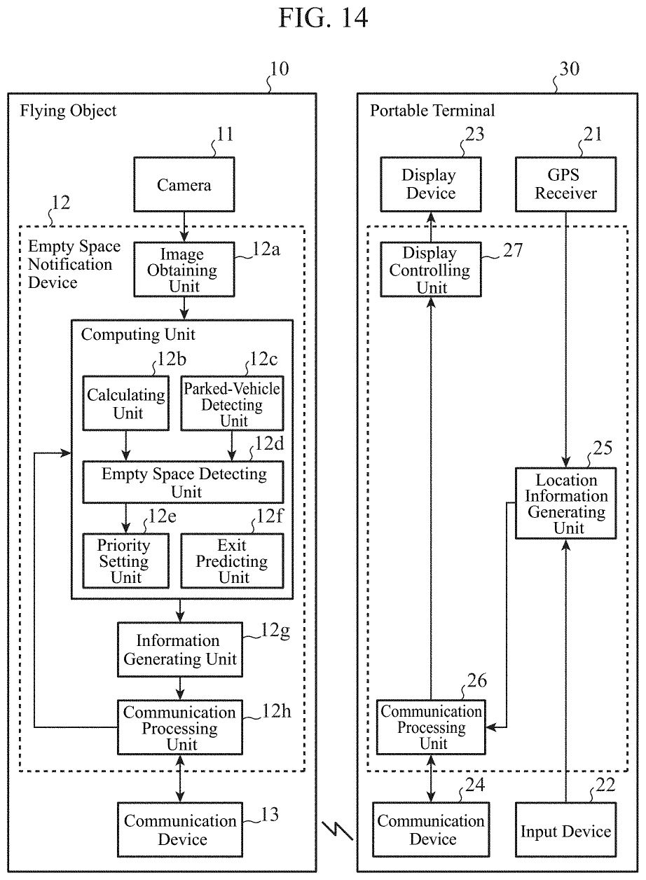

FIG. 14 is a diagram showing an empty space notification device 12 according to the second embodiment and components therearound. In FIG. 14, the configuration shown as the in-vehicle device 20 in FIG. 1 is shown as a portable terminal 30 carried by the attendant. The portable terminal 30 includes a GPS receiver 21, an input device 22, a display device 23, a communication device 24, a location information generating unit 25, a communication processing unit 26, and a display controlling unit 27 which are the same as those of the in-vehicle device 20. In addition, a flying object 10 is also configured in the same manner as that shown in FIG. 1. Therefore, components having the same or corresponding functions as/to the components already described in the first embodiment are denoted by the same reference signs, and description thereof is omitted or simplified in the second embodiment. Note that components that play roles in performing a telephone function, etc., in the portable terminal 30 are omitted in the diagram.

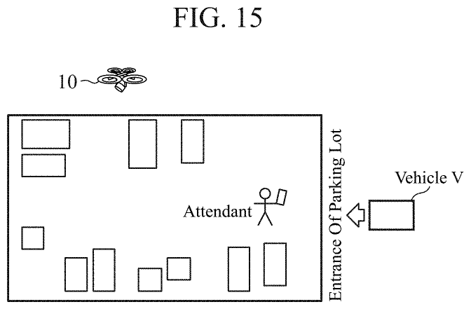

Next, an example of processing performed by the flying object 10 and the portable terminal 30 which are configured in the above-described manner will be described by referring to the flowchart shown in FIG. 4. Note that FIG. 15 is a diagram of a parking lot viewed from a bird's-eye view, and shows an exemplary disposition of an attendant and a target vehicle to be guided.

Location information transmitted at step ST1 is generated by the attendant touching a touch panel which is the input device 22. Namely, an image of the parking lot which is transmitted from the flying object 10 is already displayed on the display device 23, and the attendant touches a vehicle in the image that he/she wants to direct, using the touch panel. The location information generating unit 25 generates information indicating a touched location in the image, as location information.

Processes at steps ST2 to ST8 are as already described in the first embodiment, and thus, description thereof is omitted to avoid duplication.

Notification information generated at step ST8 is transmitted to the portable terminal 30. Then, in the portable terminal 30, the display controlling unit 27 controls the display device 23 to display an image represented by the notification information. As a result of this, the attendant can see an image such as that shown in FIG. 13, and thus can direct the target vehicle to be guided with reference to the image. Note that as described in the first embodiment, text messages may be displayed on the display device 23, or audio providing the messages may be outputted from a speaker of the portable terminal 30.

As described above, according to the empty space notification device 12 according to the second embodiment, even if a parking lot does not have parking frames, empty spaces with sizes that can accommodate the vehicle V can be detected and notified to the attendant of the parking lot through the portable terminal 30. In other words, the empty space notification device 12 can also be used for a parking lot with no parking frames. In addition, even when a parking lot with parking frames is targeted, as a matter of course, the empty space notification device 12 can likewise detect empty spaces by performing the processes described above.

Note that in the invention of the present application, a free combination of the embodiments, modifications to any component of the embodiments, or omissions of any component in the embodiments are possible within the scope of the invention.

### INDUSTRIAL APPLICABILITY

As described above, empty space notification devices according to the invention can detect empty spaces each of which is larger than a target vehicle to be guided, and thus are particularly suitable for use as devices that detect empty spaces in a parking lot with no parking frames.

### REFERENCE SIGNS LIST

10: Flying object, 11: Camera, 12: Empty space notification device, 12a: Image obtaining unit, 12b: Calculating unit, 12c: Parked-vehicle detecting unit, 12d: Empty space detecting unit, 12e: Priority setting unit, 12f: Exit predicting unit, 12g: Information generating unit, 12h: Communication processing unit, 13: Communication device, 20: In-vehicle device, 21: GPS receiver, 22: Input device, 23: Display device, 24: Communication device, 25: Location information generating unit, 26: Communication processing unit, 27: Display controlling unit, 30: Portable terminal, 101: Processing circuit, 102: Memory, and 103: CPU.

1. An empty space notification device comprising:
processing circuitry
to obtain an image of a parking lot viewed from above;
to detect a parked vehicle in the parking lot, using the image;
to detect one or more areas in the parking lot as one or more empty spaces, each of the one or more areas not having the parked vehicle detected, and being determined to be larger than a target vehicle to be guided; and
to generate notification information indicating the one or more empty spaces detected.

2. The empty space notification device according to claim 1, wherein the processing circuitry detects the one or more empty spaces using an exit space required when the parked vehicle exits, an entry space required when the target vehicle to be guided enters, and a door opening space required when a door of the target vehicle to be guided opens.

3. The empty space notification device according to claim 2, wherein the processing circuitry calculates the entry space and the door opening space, using characteristic information unique to the target vehicle to be guided.

4. The empty space notification device according to claim 1, wherein the processing circuitry
a priority for each of the one or more empty spaces detected, and
generates notification information indicating the priority for each of the one or more empty spaces.

5. The empty space notification device according to claim 1, wherein the processing circuitry
predicts a parked vehicle to exit, using a state of people getting in or out of parked vehicles in the parking lot, and
generates notification information indicating the parked vehicle predicted to exit.

6. The empty space notification device according to claim 1, wherein the processing circuitry calculates a size of the target vehicle to be guided, using the image.

7. An empty space notification system comprising:
the empty space notification device according to claim 1; and
a camera to create the image of the parking lot viewed from above.

8. An empty space notification method comprising:
obtaining an image of a parking lot viewed from above;
detecting a parked vehicle in the parking lot, using the image;
detecting one or more areas in the parking lot as one or more empty spaces, each of the one or more areas not having the parked vehicle detected, and being determined to be larger than a target vehicle to be guided; and
generating notification information indicating the one or more empty spaces detected.
